(19) United States
(12) Patent Application Publication
(10) Pub. No.: US 2026/0332193 A1
(43) Pub. Date: Oct. 22, 2026

(54) CHANNEL STATE FEEDBACK AND SEGMENTATION FOR WLAN SYSTEMS

(71) Applicant: InterDigital Patent Holdings, Inc., Wilmington, DE (US)

(72) Inventors: Hanqing LOU, Syosset, NY (US); Zinan LIN, Basking Ridge, NJ (US); Rui YANG, Melville, NY (US); Mahmoud SAAD, Montreal (CA)

(73) Assignee: InterDigital Patent Holdings, Inc., Wilmington, DE (US)

(21) Appl. No.: 19/486,737

(22) PCT Filed: Jun. 20, 2024
(86) PCT No.: PCT/US2024/034681

§ 371 Date: Nov. 21, 2025

Related U.S. Application Data
(60) Provisional application No. 63/522,616, filed on Jun. 22, 2023.

(51) Int. Cl. H04B 7/0417; H04B 7/0452; H04B 7/06; H04W 84/12

(52) U.S. Cl. CPC H04B 7/0417; H04B 7/0452; H04B 7/0632; H04B 7/0658; H04W 84/12

(57) ABSTRACT

Methods implemented in a beamformee station (STA) are disclosed including receiving a sounding null data packet (NDP) announcement frame and NDP frame and preparing a compressed beamforming/channel quality indicator (CQI) report comprising a compressed beamforming report and a multi-user (MU) exclusive beamforming report wherein the compressed beamforming/CQU report comprises segments, each comprising one of: a portion of the compressed beamforming report, a portion of the compressed beamforming report and a portion of the MU exclusive beamforming report, or a portion of the MU exclusive beamforming report. Various other embodiments are detailed.

### CROSS-REFERENCE TO RELATED APPLICATIONS

This application claims the benefit of U.S. Provisional Application No. 63/522,616, filed Jun. 22, 2023, the contents of which are incorporated herein by reference.

### BACKGROUND

In advanced wireless local area network (WLAN) systems, extremely high throughput (EHT) stations (STAs) use a sounding protocol to determine channel state information. The sounding protocol provides explicit feedback mechanisms, defined as EHT non-trigger-based (non-TB) sounding and EHT trigger-based (TB) sounding, where the EHT beamformer (BFer) determines the channel state by transmitting a training signal (i.e., an EHT sounding null data packet (NDP) to the EHT beamformee (BFee), which sends back a transformed estimate of the channel state. The EHT beamformer uses this estimate to derive a steering matrix.

The EHT beamformee returns an estimate of the channel state in an EHT compressed beamforming/CQI report carried in one or more EHT Compressed Beamforming/CQI frames. There are three types of EHT compressed beamforming/CQI reports. For single user (SU) feedback, the EHT compressed beamforming/CQI report consists of an EHT Compressed Beamforming Report field. For multi-user (MU) feedback, the EHT compressed beamforming/CQI report consists of an EHT Compressed Beamforming Report field and EHT MU Exclusive Beamforming Report field. For CQI feedback, the EHT compressed beamforming/CQI report consists of an EHT CQI Report field.

Both beamformer and beamformee should know the size of Compressed Beamforming Report field and MU Exclusive Beamforming Report field. A detailed segmentation procedure is therefore required.

### SUMMARY

Aspects features and advantages of the disclosed embodiments, may address one or more of the foregoing needs or desires through methods and devices for preparing and transmitting a segmented compressed beamforming/channel quality indictor (CQI) report described hereinafter.

In one aspect, a method for a station (STA) includes: receiving a sounding null data packet (NDP) announcement (NDPA) frame; receiving an NDP frame; generating a compressed beamforming/channel quality indicator (CQI) report comprising a compressed beamforming report and a multi-user (MU) exclusive beamforming report; generating a plurality of segments of the compressed beamforming/CQI report, each of the plurality of segments comprising one of: a portion of the compressed beamforming report, a portion of the compressed beamforming report and a portion of the MU exclusive beamforming report, or a portion of the MU exclusive beamforming report; and transmitting each of the plurality of segments in a separate one of a plurality of compressed beamforming/CQI frames. Additionally/alternatively, one of the segments comprises portions of the compressed beamforming report and portions of the MU exclusive beamforming report. Additionally/alternatively, at least one of the segments consists of portions of the compressed beamforming report. Additionally/alternatively, at least another of the segments consists of portions of the MU exclusive beamforming report. Additionally/alternatively, the method is performed in a case that the compressed beamforming report exceeds a predetermined frame size.

In a further aspect, a station (STA) comprises: a processor; and a transceiver; the processor and transceiver configured to receive a sounding null data packet (NDP) announcement (NDPA) frame; the processor and transceiver are further configured to receive an NDP frame; the processor is configured to generate a compressed beamforming/channel quality indicator (CQI) report comprising a compressed beamforming report and a multi-user (MU) exclusive beamforming report; the processor is further configured to generate a plurality of segments of the compressed beamforming/CQI report, each of the plurality of segments comprising one of: a portion of the compressed beamforming report; a portion of the compressed beamforming report and a portion of the MU exclusive beamforming report; or a portion of the MU exclusive beamforming report; and the processor and transceiver further are configured to transmit each of the plurality of segments in a separate one of a plurality of compressed beamforming/CQI frames. Additionally/alternatively, one of the segments comprises portions of the compressed beamforming report and portions of the MU exclusive beamforming report. Additionally/alternatively, wherein at least one of the segments consists of portions of the compressed beamforming report. Additionally/alternatively, at least another of the segments consists of portions of the MU exclusive beamforming report.

In further aspect, a method for a beamformee STA comprises: receiving a sounding null data packet (NDP) announcement (NDPA) frame; receiving an NDP frame; generating a plurality of segments of the compressed beamforming/CQI report, each of the plurality of segments comprising one of: at least a portion of the compressed beamforming report, and at least a portion of the MU exclusive beamforming report; and transmit each of the plurality of segments in a separate one of a plurality of compressed beamforming/CQI frames. Additionally/alternatively, each segment comprises the MU exclusive beamforming report. Additionally/alternatively, the plurality of segments comprised segments of equal length and each equal length segment comprises a compressed beamforming report portion of length N1 and a MU exclusive beamforming portion of length N2. Additionally/alternatively, the method comprises generating a final segment that is shorter than each of the plurality of equal length segments. Additionally/alternatively, the method is performed in a case that the compressed beamforming report exceeds a predetermined frame size.

### BRIEF DESCRIPTION OF THE DRAWINGS

A more detailed understanding may be had from the following description, given by way of example in conjunction with the accompanying drawings, wherein like reference numerals in the figures indicate like elements, and wherein:

FIG. 1A is a system diagram illustrating an example communications system in which one or more disclosed embodiments may be implemented;

FIG. 1B is a system diagram illustrating an example wireless transmit/receive unit (WTRU) that may be used within the communications system illustrated in FIG. 1A according to an embodiment;

FIG. 1C is a system diagram illustrating an example radio access network (RAN) and an example core network (CN) that may be used within the communications system illustrated in FIG. 1A according to an embodiment;

FIG. 1D is a system diagram illustrating a further example RAN and a further example CN that may be used within the communications system illustrated in FIG. 1A according to an embodiment;

FIG. 2 is a diagram for a compressed beamforming report according to an embodiment;

FIG. 3 is a diagram for a compressed beamforming report according to a further embodiment;

FIG. 4 is a diagram for a compressed beamforming report according to a further embodiment;

FIG. 5 is a flow chart for an exemplary process according to an embodiment;

FIG. 6 is a flow chart for a further exemplary process according to an embodiment; and

FIG. 7 is a flow chart for a further exemplary process according to an embodiment.

### DETAILED DESCRIPTION

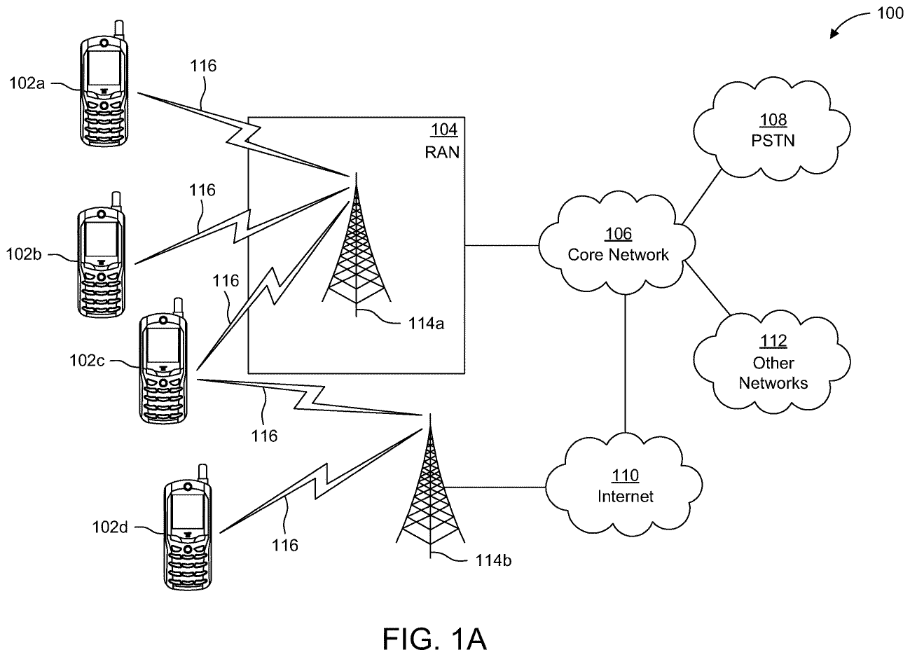

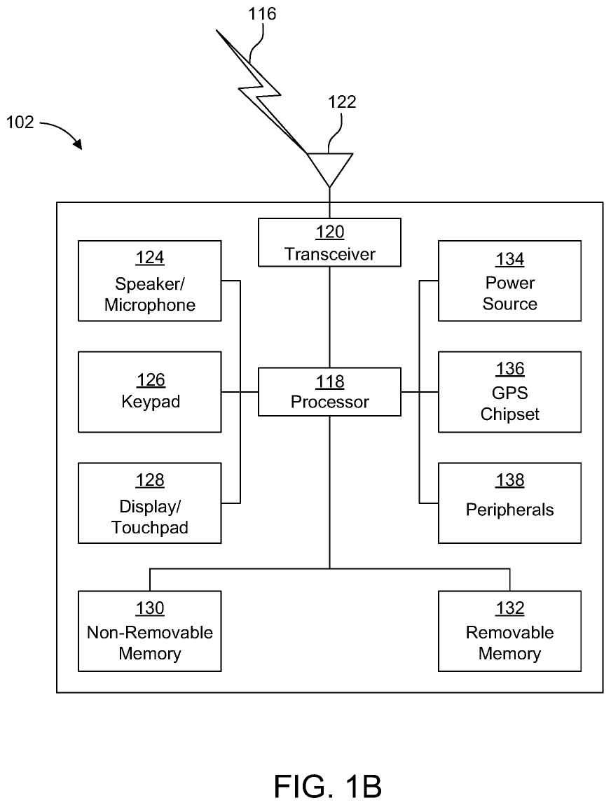

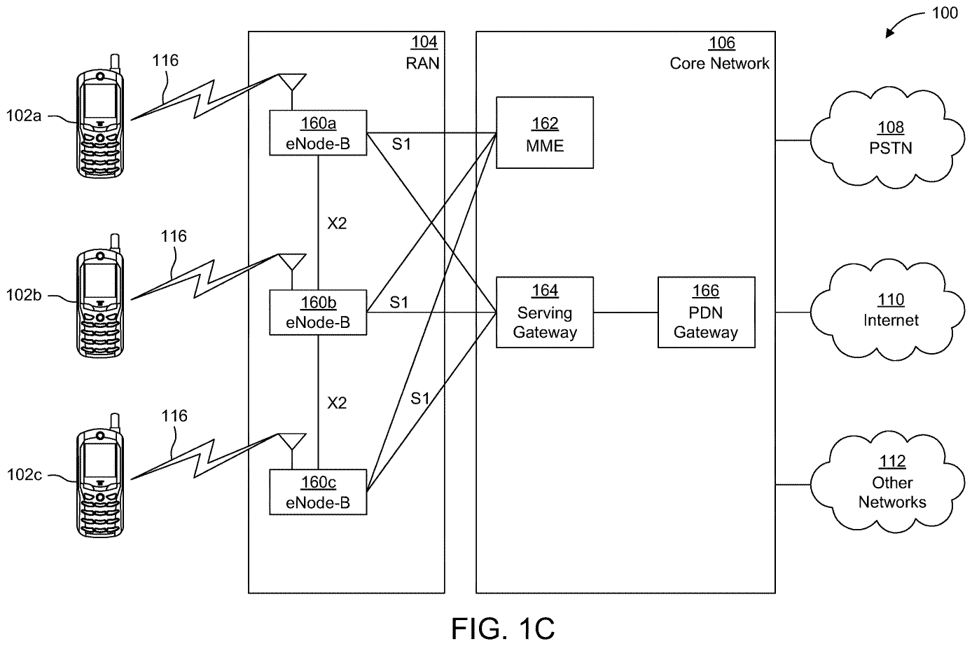

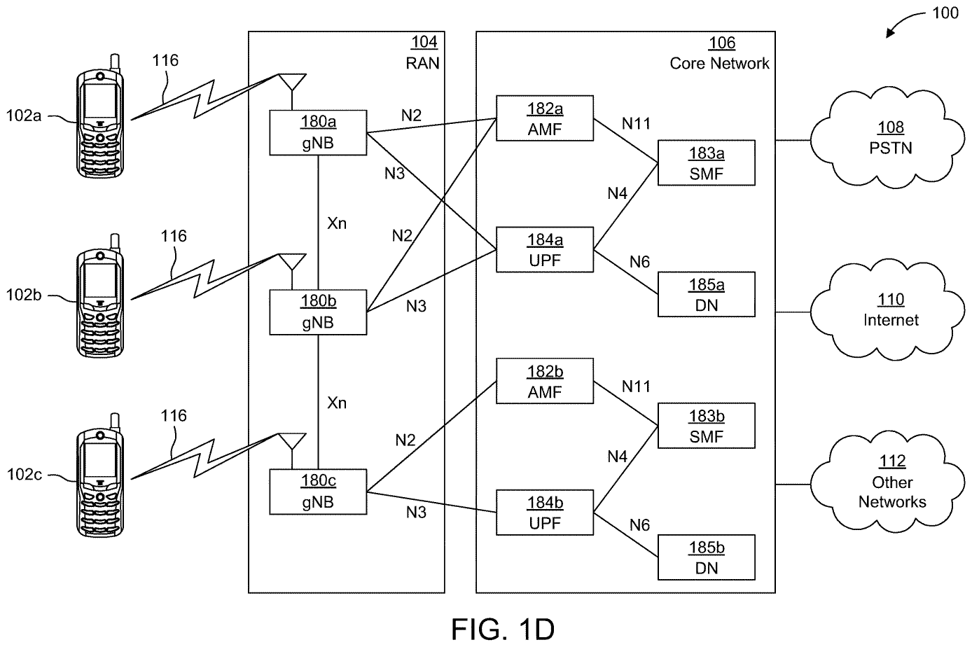

FIG. 1A is a diagram illustrating an example communications system 100 in which one or more disclosed embodiments may be implemented. The communications system 100 may be a multiple access system that provides content, such as voice, data, video, messaging, broadcast, etc., to multiple wireless users. The communications system 100 may enable multiple wireless users to access such content through the sharing of system resources, including wireless bandwidth. For example, the communications systems 100 may employ one or more channel access methods, such as code division multiple access (CDMA), time division multiple access (TDMA), frequency division multiple access (FDMA), orthogonal FDMA (OFDMA), single-carrier FDMA (SC-FDMA), zero-tail unique-word discrete Fourier transform Spread OFDM (ZT-UW-DFT-S-OFDM), unique word OFDM (UW-OFDM), resource block-filtered OFDM, filter bank multicarrier (FBMC), and the like.

As shown in FIG. 1A, the communications system 100 may include wireless transmit/receive units (WTRUs) 102a, 102b, 102c, 102d, a radio access network (RAN) 104, a core network (CN) 106, a public switched telephone network (PSTN) 108, the Internet 110, and other networks 112, though it will be appreciated that the disclosed embodiments contemplate any number of WTRUs, base stations, networks, and/or network elements. Each of the WTRUs 102a, 102b, 102c, 102d may be any type of device configured to operate and/or communicate in a wireless environment. By way of example, the WTRUs 102a, 102b, 102c, 102d, any of which may be referred to as a station (STA), may be configured to transmit and/or receive wireless signals and may include a user equipment (UE), a mobile station, a fixed or mobile subscriber unit, a subscription-based unit, a pager, a cellular telephone, a personal digital assistant (PDA), a smartphone, a laptop, a netbook, a personal computer, a wireless sensor, a hotspot or Mi-Fi device, an Internet of Things (IoT) device, a watch or other wearable, a head-mounted display (HMD), a vehicle, a drone, a medical device and applications (e.g., remote surgery), an industrial device and applications (e.g., a robot and/or other wireless devices operating in an industrial and/or an automated processing chain contexts), a consumer electronics device, a device operating on commercial and/or industrial wireless networks, and the like. Any of the WTRUs 102a, 102b, 102c and 102d may be interchangeably referred to as a UE.

The communications systems 100 may also include a base station 114a and/or a base station 114b. Each of the base stations 114a, 114b may be any type of device configured to wirelessly interface with at least one of the WTRUs 102a, 102b, 102c, 102d to facilitate access to one or more communication networks, such as the CN 106, the Internet 110, and/or the other networks 112. By way of example, the base stations 114a, 114b may be a base transceiver station (BTS), a NodeB, an eNode B (eNB), a Home Node B, a Home eNode B, a next generation NodeB, such as a gNode B (gNB), a new radio (NR) NodeB, a site controller, an access point (AP), a wireless router, and the like. While the base stations 114a, 114b are each depicted as a single element, it will be appreciated that the base stations 114a, 114b may include any number of interconnected base stations and/or network elements.

The base station 114a may be part of the RAN 104, which may also include other base stations and/or network elements (not shown), such as a base station controller (BSC), a radio network controller (RNC), relay nodes, and the like. The base station 114a and/or the base station 114b may be configured to transmit and/or receive wireless signals on one or more carrier frequencies, which may be referred to as a cell (not shown). These frequencies may be in licensed spectrum, unlicensed spectrum, or a combination of licensed and unlicensed spectrum. A cell may provide coverage for a wireless service to a specific geographical area that may be relatively fixed or that may change over time. The cell may further be divided into cell sectors. For example, the cell associated with the base station 114a may be divided into three sectors. Thus, in one embodiment, the base station 114a may include three transceivers, i.e., one for each sector of the cell. In an embodiment, the base station 114a may employ multiple-input multiple output (MIMO) technology and may utilize multiple transceivers for each sector of the cell. For example, beamforming may be used to transmit and/or receive signals in desired spatial directions.

The base stations 114a, 114b may communicate with one or more of the WTRUs 102a, 102b, 102c, 102d over an air interface 116, which may be any suitable wireless communication link (e.g., radio frequency (RF), microwave, centimeter wave, micrometer wave, infrared (IR), ultraviolet (UV), visible light, etc.). The air interface 116 may be established using any suitable radio access technology (RAT).

More specifically, as noted above, the communications system 100 may be a multiple access system and may employ one or more channel access schemes, such as CDMA, TDMA, FDMA, OFDMA, SC-FDMA, and the like. For example, the base station 114a in the RAN 104 and the WTRUs 102a, 102b, 102c may implement a radio technology such as Universal Mobile Telecommunications System (UMTS) Terrestrial Radio Access (UTRA), which may establish the air interface 116 using wideband CDMA (WCDMA). WCDMA may include communication protocols such as High-Speed Packet Access (HSPA) and/or Evolved HSPA (HSPA+). HSPA may include High-Speed Downlink (DL) Packet Access (HSDPA) and/or High-Speed Uplink (UL) Packet Access (HSUPA).

In an embodiment, the base station 114a and the WTRUs 102a, 102b, 102c may implement a radio technology such as Evolved UMTS Terrestrial Radio Access (E-UTRA), which may establish the air interface 116 using Long Term Evolution (LTE) and/or LTE-Advanced (LTE-A) and/or LTE-Advanced Pro (LTE-A Pro).

In an embodiment, the base station 114a and the WTRUs 102a, 102b, 102c may implement a radio technology such as NR Radio Access, which may establish the air interface 116 using NR.

In an embodiment, the base station 114a and the WTRUs 102a, 102b, 102c may implement multiple radio access technologies. For example, the base station 114a and the WTRUs 102a, 102b, 102c may implement LTE radio access and NR radio access together, for instance using dual connectivity (DC) principles. Thus, the air interface utilized by WTRUs 102a, 102b, 102c may be characterized by multiple types of radio access technologies and/or transmissions sent to/from multiple types of base stations (e.g., an eNB and a gNB).

In other embodiments, the base station 114a and the WTRUs 102a, 102b, 102c may implement radio technologies such as IEEE 802.11 (i.e., Wireless Fidelity (WiFi), IEEE 802.16 (i.e., Worldwide Interoperability for Microwave Access (WiMAX)), CDMA2000, CDMA2000 1×, CDMA2000 EV-DO, Interim Standard 2000 (IS-2000), Interim Standard 95 (IS-95), Interim Standard 856 (IS-856), Global System for Mobile communications (GSM), Enhanced Data rates for GSM Evolution (EDGE), GSM EDGE (GERAN), and the like.

The base station 114b in FIG. 1A may be a wireless router, Home Node B, Home eNode B, or access point, for example, and may utilize any suitable RAT for facilitating wireless connectivity in a localized area, such as a place of business, a home, a vehicle, a campus, an industrial facility, an air corridor (e.g., for use by drones), a roadway, and the like. In one embodiment, the base station 114b and the WTRUs 102c, 102d may implement a radio technology such as IEEE 802.11 to establish a wireless local area network (WLAN). In an embodiment, the base station 114b and the WTRUs 102c, 102d may implement a radio technology such as IEEE 802.15 to establish a wireless personal area network (WPAN). In yet another embodiment, the base station 114b and the WTRUs 102c, 102d may utilize a cellular-based RAT (e.g., WCDMA, CDMA2000, GSM, LTE, LTE-A, LTE-A Pro, NR etc.) to establish a picocell or femtocell. As shown in FIG. 1A, the base station 114b may have a direct connection to the Internet 110. Thus, the base station 114b may not be required to access the Internet 110 via the CN 106.

The RAN 104 may be in communication with the CN 106, which may be any type of network configured to provide voice, data, applications, and/or voice over internet protocol (VoIP) services to one or more of the WTRUs 102a, 102b, 102c, 102d. The data may have varying quality of service (QoS) requirements, such as differing throughput requirements, latency requirements, error tolerance requirements, reliability requirements, data throughput requirements, mobility requirements, and the like. The CN 106 may provide call control, billing services, mobile location-based services, pre-paid calling, Internet connectivity, video distribution, etc., and/or perform high-level security functions, such as user authentication. Although not shown in FIG. 1A, it will be appreciated that the RAN 104 and/or the CN 106 may be in direct or indirect communication with other RANs that employ the same RAT as the RAN 104 or a different RAT. For example, in addition to being connected to the RAN 104, which may be utilizing a NR radio technology, the CN 106 may also be in communication with another RAN (not shown) employing a GSM, UMTS, CDMA 2000, WiMAX, E-UTRA, or WiFi radio technology.

The CN 106 may also serve as a gateway for the WTRUs 102a, 102b, 102c, 102d to access the PSTN 108, the Internet 110, and/or the other networks 112. The PSTN 108 may include circuit-switched telephone networks that provide plain old telephone service (POTS). The Internet 110 may include a global system of interconnected computer networks and devices that use common communication protocols, such as the transmission control protocol (TCP), user datagram protocol (UDP) and/or the internet protocol (IP) in the TCP/IP internet protocol suite. The networks 112 may include wired and/or wireless communications networks owned and/or operated by other service providers. For example, the networks 112 may include another CN connected to one or more RANs, which may employ the same RAT as the RAN 104 or a different RAT.

Some or all of the WTRUs 102a, 102b, 102c, 102d in the communications system 100 may include multi-mode capabilities (e.g., the WTRUs 102a, 102b, 102c, 102d may include multiple transceivers for communicating with different wireless networks over different wireless links). For example, the WTRU 102c shown in FIG. 1A may be configured to communicate with the base station 114a, which may employ a cellular-based radio technology, and with the base station 114b, which may employ an IEEE 802 radio technology.

FIG. 1B is a system diagram illustrating an example WTRU 102. As shown in FIG. 1B, the WTRU 102 may include a processor 118, a transceiver 120, a transmit/receive element 122, a speaker/microphone 124, a keypad 126, a display/touchpad 128, non-removable memory 130, removable memory 132, a power source 134, a global positioning system (GPS) chipset 136, and/or other peripherals 138, among others. It will be appreciated that the WTRU 102 may include any sub-combination of the foregoing elements while remaining consistent with an embodiment.

The processor 118 may be a general purpose processor, a special purpose processor, a conventional processor, a digital signal processor (DSP), a plurality of microprocessors, one or more microprocessors in association with a DSP core, a controller, a microcontroller, Application Specific Integrated Circuits (ASICs), Field Programmable Gate Arrays (FPGAs), any other type of integrated circuit (IC), a state machine, and the like. The processor 118 may perform signal coding, data processing, power control, input/output processing, and/or any other functionality that enables the WTRU 102 to operate in a wireless environment. The processor 118 may be coupled to the transceiver 120, which may be coupled to the transmit/receive element 122. While FIG. 1B depicts the processor 118 and the transceiver 120 as separate components, it will be appreciated that the processor 118 and the transceiver 120 may be integrated together in an electronic package or chip.

The transmit/receive element 122 may be configured to transmit signals to, or receive signals from, a base station (e.g., the base station 114a) over the air interface 116. For example, in one embodiment, the transmit/receive element 122 may be an antenna configured to transmit and/or receive RF signals. In an embodiment, the transmit/receive element 122 may be an emitter/detector configured to transmit and/or receive IR, UV, or visible light signals, for example. In yet another embodiment, the transmit/receive element 122 may be configured to transmit and/or receive both RF and light signals. It will be appreciated that the transmit/receive element 122 may be configured to transmit and/or receive any combination of wireless signals.

Although the transmit/receive element 122 is depicted in FIG. 1B as a single element, the WTRU 102 may include any number of transmit/receive elements 122. More specifically, the WTRU 102 may employ MIMO technology. Thus, in one embodiment, the WTRU 102 may include two or more transmit/receive elements 122 (e.g., multiple antennas) for transmitting and receiving wireless signals over the air interface 116.

The transceiver 120 may be configured to modulate the signals that are to be transmitted by the transmit/receive element 122 and to demodulate the signals that are received by the transmit/receive element 122. As noted above, the WTRU 102 may have multi-mode capabilities. Thus, the transceiver 120 may include multiple transceivers for enabling the WTRU 102 to communicate via multiple RATs, such as NR and IEEE 802.11, for example.

The processor 118 of the WTRU 102 may be coupled to, and may receive user input data from, the speaker/microphone 124, the keypad 126, and/or the display/touchpad 128 (e.g., a liquid crystal display (LCD) display unit or organic light-emitting diode (OLED) display unit). The processor 118 may also output user data to the speaker/microphone 124, the keypad 126, and/or the display/touchpad 128. In addition, the processor 118 may access information from, and store data in, any type of suitable memory, such as the non-removable memory 130 and/or the removable memory 132. The non-removable memory 130 may include random-access memory (RAM), read-only memory (ROM), a hard disk, or any other type of memory storage device. The removable memory 132 may include a subscriber identity module (SIM) card, a memory stick, a secure digital (SD) memory card, and the like. In other embodiments, the processor 118 may access information from, and store data in, memory that is not physically located on the WTRU 102, such as on a server or a home computer (not shown).

The processor 118 may receive power from the power source 134, and may be configured to distribute and/or control the power to the other components in the WTRU 102. The power source 134 may be any suitable device for powering the WTRU 102. For example, the power source 134 may include one or more dry cell batteries (e.g., nickel-cadmium (NiCd), nickel-zinc (NiZn), nickel metal hydride (NiMH), lithium-ion (Li-ion), etc.), solar cells, fuel cells, and the like.

The processor 118 may also be coupled to the GPS chipset 136, which may be configured to provide location information (e.g., longitude and latitude) regarding the current location of the WTRU 102. In addition to, or in lieu of, the information from the GPS chipset 136, the WTRU 102 may receive location information over the air interface 116 from a base station (e.g., base stations 114a, 114b) and/or determine its location based on the timing of the signals being received from two or more nearby base stations. It will be appreciated that the WTRU 102 may acquire location information by way of any suitable location-determination method while remaining consistent with an embodiment.

The processor 118 may further be coupled to other peripherals 138, which may include one or more software and/or hardware modules that provide additional features, functionality and/or wired or wireless connectivity. For example, the peripherals 138 may include an accelerometer, an e-compass, a satellite transceiver, a digital camera (for photographs and/or video), a universal serial bus (USB) port, a vibration device, a television transceiver, a hands free headset, a Bluetooth® module, a frequency modulated (FM) radio unit, a digital music player, a media player, a video game player module, an Internet browser, a Virtual Reality and/or Augmented Reality (VR/AR) device, an activity tracker, and the like. The peripherals 138 may include one or more sensors. The sensors may be one or more of a gyroscope, an accelerometer, a hall effect sensor, a magnetometer, an orientation sensor, a proximity sensor, a temperature sensor, a time sensor; a geolocation sensor, an altimeter, a light sensor, a touch sensor, a magnetometer, a barometer, a gesture sensor, a biometric sensor, a humidity sensor and the like.

The WTRU 102 may include a full duplex radio for which transmission and reception of some or all of the signals (e.g., associated with particular subframes for both the UL (e.g., for transmission) and DL (e.g., for reception) may be concurrent and/or simultaneous. The full duplex radio may include an interference management unit to reduce and or substantially eliminate self-interference via either hardware (e.g., a choke) or signal processing via a processor (e.g., a separate processor (not shown) or via processor 118). In an embodiment, the WTRU 102 may include a half-duplex radio for which transmission and reception of some or all of the signals (e.g., associated with particular subframes for either the UL (e.g., for transmission) or the DL (e.g., for reception).

FIG. 1C is a system diagram illustrating the RAN 104 and the CN 106 according to an embodiment. As noted above, the RAN 104 may employ an E-UTRA radio technology to communicate with the WTRUs 102a, 102b, 102c over the air interface 116. The RAN 104 may also be in communication with the CN 106.

The RAN 104 may include eNode-Bs 160a, 160b, 160c, though it will be appreciated that the RAN 104 may include any number of eNode-Bs while remaining consistent with an embodiment. The eNode-Bs 160a, 160b, 160c may each include one or more transceivers for communicating with the WTRUs 102a, 102b, 102c over the air interface 116. In one embodiment, the eNode-Bs 160a, 160b, 160c may implement MIMO technology. Thus, the eNode-B 160a, for example, may use multiple antennas to transmit wireless signals to, and/or receive wireless signals from, the WTRU 102a.

Each of the eNode-Bs 160a, 160b, 160c may be associated with a particular cell (not shown) and may be configured to handle radio resource management decisions, handover decisions, scheduling of users in the UL and/or DL, and the like. As shown in FIG. 1C, the eNode-Bs 160a, 160b, 160c may communicate with one another over an X2 interface.

The CN 106 shown in FIG. 1C may include a mobility management entity (MME) 162, a serving gateway (SGW) 164, and a packet data network (PDN) gateway (PGW) 166. While the foregoing elements are depicted as part of the CN 106, it will be appreciated that any of these elements may be owned and/or operated by an entity other than the CN operator.

The MME 162 may be connected to each of the eNode-Bs 162a, 162b, 162c in the RAN 104 via an S1 interface and may serve as a control node. For example, the MME 162 may be responsible for authenticating users of the WTRUs 102a, 102b, 102c, bearer activation/deactivation, selecting a particular serving gateway during an initial attach of the WTRUs 102a, 102b, 102c, and the like. The MME 162 may provide a control plane function for switching between the RAN 104 and other RANs (not shown) that employ other radio technologies, such as GSM and/or WCDMA.

The SGW 164 may be connected to each of the eNode Bs 160a, 160b, 160c in the RAN 104 via the S1 interface. The SGW 164 may generally route and forward user data packets to/from the WTRUs 102a, 102b, 102c. The SGW 164 may perform other functions, such as anchoring user planes during inter-eNode B handovers, triggering paging when DL data is available for the WTRUs 102a, 102b, 102c, managing and storing contexts of the WTRUs 102a, 102b, 102c, and the like.

The SGW 164 may be connected to the PGW 166, which may provide the WTRUs 102a, 102b, 102c with access to packet-switched networks, such as the Internet 110, to facilitate communications between the WTRUs 102a, 102b, 102c and IP-enabled devices.

The CN 106 may facilitate communications with other networks. For example, the CN 106 may provide the WTRUs 102a, 102b, 102c with access to circuit-switched networks, such as the PSTN 108, to facilitate communications between the WTRUs 102a, 102b, 102c and traditional land-line communications devices. For example, the CN 106 may include, or may communicate with, an IP gateway (e.g., an IP multimedia subsystem (IMS) server) that serves as an interface between the CN 106 and the PSTN 108. In addition, the CN 106 may provide the WTRUs 102a, 102b, 102c with access to the other networks 112, which may include other wired and/or wireless networks that are owned and/or operated by other service providers.

Although the WTRU is described in FIGS. 1A-1D as a wireless terminal, it is contemplated that in certain representative embodiments that such a terminal may use (e.g., temporarily or permanently) wired communication interfaces with the communication network.

In representative embodiments, the other network 112 may be a WLAN.

A WLAN in Infrastructure Basic Service Set (BSS) mode may have an Access Point (AP) for the BSS and one or more stations (STAs) associated with the AP. The AP may have access or an interface to a Distribution System (DS) or another type of wired/wireless network that carries traffic in to and/or out of the BSS. Traffic to STAs that originates from outside the BSS may arrive through the AP and may be delivered to the STAs. Traffic originating from STAs to destinations outside the BSS may be sent to the AP to be delivered to respective destinations. Traffic between STAs within the BSS may be sent through the AP, for example, where the source STA may send traffic to the AP and the AP may deliver the traffic to the destination STA. The traffic between STAs within a BSS may be considered and/or referred to as peer-to-peer traffic. The peer-to-peer traffic may be sent between (e.g., directly between) the source and destination STAs with a direct link setup (DLS). In certain representative embodiments, the DLS may use an 802.11e DLS or an 802.11z tunneled DLS (TDLS). A WLAN using an Independent BSS (IBSS) mode may not have an AP, and the STAs (e.g., all of the STAs) within or using the IBSS may communicate directly with each other. The IBSS mode of communication may sometimes be referred to herein as an “ad-hoc” mode of communication.

When using the 802.11ac infrastructure mode of operation or a similar mode of operations, the AP may transmit a beacon on a fixed channel, such as a primary channel. The primary channel may be a fixed width (e.g., 20 MHz wide bandwidth) or a dynamically set width. The primary channel may be the operating channel of the BSS and may be used by the STAs to establish a connection with the AP. In certain representative embodiments, Carrier Sense Multiple Access with Collision Avoidance (CSMA/CA) may be implemented, for example in 802.11 systems. For CSMA/CA, the STAs (e.g., every STA), including the AP, may sense the primary channel. If the primary channel is sensed/detected and/or determined to be busy by a particular STA, the particular STA may back off. One STA (e.g., only one station) may transmit at any given time in a given BSS.

High Throughput (HT) STAs may use a 40 MHz wide channel for communication, for example, via a combination of the primary 20 MHz channel with an adjacent or nonadjacent 20 MHz channel to form a 40 MHz wide channel.

Very High Throughput (VHT) STAs may support 20 MHz, 40 MHz, 80 MHz, and/or 160 MHz wide channels. The 40 MHz, and/or 80 MHz, channels may be formed by combining contiguous 20 MHz channels. A 160 MHz channel may be formed by combining 8 contiguous 20 MHz channels, or by combining two non-contiguous 80 MHz channels, which may be referred to as an 80+80 configuration. For the 80+80 configuration, the data, after channel encoding, may be passed through a segment parser that may divide the data into two streams. Inverse Fast Fourier Transform (IFFT) processing, and time domain processing, may be done on each stream separately. The streams may be mapped on to the two 80 MHz channels, and the data may be transmitted by a transmitting STA. At the receiver of the receiving STA, the above described operation for the 80+80 configuration may be reversed, and the combined data may be sent to the Medium Access Control (MAC).

Sub 1 GHz modes of operation are supported by 802.11af and 802.11ah. The channel operating bandwidths, and carriers, are reduced in 802.11af and 802.11ah relative to those used in 802.11n, and 802.11ac. 802.11af supports 5 MHz, 10 MHz, and 20 MHz bandwidths in the TV White Space (TVWS) spectrum, and 802.11ah supports 1 MHz, 2 MHz, 4 MHz, 8 MHz, and 16 MHz bandwidths using non-TVWS spectrum. 802.11ah may support Meter Type Control/Machine-Type Communications (MTC), such as MTC devices in a macro coverage area. MTC devices may have certain capabilities, for example, limited capabilities including support for (e.g., only support for) certain and/or limited bandwidths. The MTC devices may include a battery with a battery life above a threshold (e.g., to maintain a very long battery life).

WLAN systems, which may support multiple channels, and channel bandwidths, such as 802.11n, 802.11ac, 802.11af, and 802.11ah, include a channel which may be designated as the primary channel. The primary channel may have a bandwidth equal to the largest common operating bandwidth supported by all STAs in the BSS. The bandwidth of the primary channel may be set and/or limited by a STA, from among all STAs in operating in a BSS, which supports the smallest bandwidth operating mode. In 802.11ah, for example, the primary channel may be 1 MHz wide for STAs (e.g., MTC type devices) that support (e.g., only support) a 1 MHz mode, even if the AP, and other STAs in the BSS support 2 MHz, 4 MHz, 8 MHz, 16 MHz, and/or other channel bandwidth operating modes. Carrier sensing and/or Network Allocation Vector (NAV) settings may depend on the status of the primary channel. If the primary channel is busy, for example, due to a STA (which supports only a 1 MHz operating mode) transmitting to the AP, all available frequency bands may be considered busy even though a majority of the available frequency bands remains idle.

In the United States, the available frequency bands, which may be used by 802.11ah, are from 902 MHz to 928 MHz. In Korea, the available frequency bands are from 917.5 MHz to 923.5 MHz. In Japan, the available frequency bands are from 916.5 MHz to 927.5 MHz. The total bandwidth available for 802.11ah is 6 MHz to 26 MHz depending on the country code.

FIG. 1D is a system diagram illustrating the RAN 104 and the CN 106 according to an embodiment. As noted above, the RAN 104 may employ an NR radio technology to communicate with the WTRUs 102a, 102b, 102c over the air interface 116. The RAN 104 may also be in communication with the CN 106.

The RAN 104 may include gNBs 180a, 180b, 180c, though it will be appreciated that the RAN 104 may include any number of gNBs while remaining consistent with an embodiment. The gNBs 180a, 180b, 180c may each include one or more transceivers for communicating with the WTRUs 102a, 102b, 102c over the air interface 116. In one embodiment, the gNBs 180a, 180b, 180c may implement MIMO technology. For example, gNBs 180a, 108b may utilize beamforming to transmit signals to and/or receive signals from the gNBs 180a, 180b, 180c. Thus, the gNB 180a, for example, may use multiple antennas to transmit wireless signals to, and/or receive wireless signals from, the WTRU 102a. In an embodiment, the gNBs 180a, 180b, 180c may implement carrier aggregation technology. For example, the gNB 180a may transmit multiple component carriers to the WTRU 102a (not shown). A subset of these component carriers may be on unlicensed spectrum while the remaining component carriers may be on licensed spectrum. In an embodiment, the gNBs 180a, 180b, 180c may implement Coordinated Multi-Point (COMP) technology. For example, WTRU 102a may receive coordinated transmissions from gNB 180a and gNB 180b (and/or gNB 180c).

The WTRUs 102a, 102b, 102c may communicate with gNBs 180a, 180b, 180c using transmissions associated with a scalable numerology. For example, the OFDM symbol spacing and/or OFDM subcarrier spacing may vary for different transmissions, different cells, and/or different portions of the wireless transmission spectrum. The WTRUs 102a, 102b, 102c may communicate with gNBs 180a, 180b, 180c using subframe or transmission time intervals (TTIs) of various or scalable lengths (e.g., containing a varying number of OFDM symbols and/or lasting varying lengths of absolute time).

The gNBs 180a, 180b, 180c may be configured to communicate with the WTRUs 102a, 102b, 102c in a standalone configuration and/or a non-standalone configuration. In the standalone configuration, WTRUs 102a, 102b, 102c may communicate with gNBs 180a, 180b, 180c without also accessing other RANs (e.g., such as eNode-Bs 160a, 160b, 160c). In the standalone configuration, WTRUs 102a, 102b, 102c may utilize one or more of gNBs 180a, 180b, 180c as a mobility anchor point. In the standalone configuration, WTRUs 102a, 102b, 102c may communicate with gNBs 180a, 180b, 180c using signals in an unlicensed band. In a non-standalone configuration WTRUs 102a, 102b, 102c may communicate with/connect to gNBs 180a, 180b, 180c while also communicating with/connecting to another RAN such as eNode-Bs 160a, 160b, 160c. For example, WTRUs 102a, 102b, 102c may implement DC principles to communicate with one or more gNBs 180a, 180b, 180c and one or more eNode-Bs 160a, 160b, 160c substantially simultaneously. In the non-standalone configuration, eNode-Bs 160a, 160b, 160c may serve as a mobility anchor for WTRUs 102a, 102b, 102c and gNBs 180a, 180b, 180c may provide additional coverage and/or throughput for servicing WTRUs 102a, 102b, 102c.

Each of the gNBs 180a, 180b, 180c may be associated with a particular cell (not shown) and may be configured to handle radio resource management decisions, handover decisions, scheduling of users in the UL and/or DL, support of network slicing, DC, interworking between NR and E-UTRA, routing of user plane data towards User Plane Function (UPF) 184a, 184b, routing of control plane information towards Access and Mobility Management Function (AMF) 182a, 182b and the like. As shown in FIG. 1D, the gNBs 180a, 180b, 180c may communicate with one another over an Xn interface.

The CN 106 shown in FIG. 1D may include at least one AMF 182a, 182b, at least one UPF 184a, 184b, at least one Session Management Function (SMF) 183a, 183b, and possibly a Data Network (DN) 185a, 185b. While the foregoing elements are depicted as part of the CN 106, it will be appreciated that any of these elements may be owned and/or operated by an entity other than the CN operator.

The AMF 182a, 182b may be connected to one or more of the gNBs 180a, 180b, 180c in the RAN 104 via an N2 interface and may serve as a control node. For example, the AMF 182a, 182b may be responsible for authenticating users of the WTRUs 102a, 102b, 102c, support for network slicing (e.g., handling of different protocol data unit (PDU) sessions with different requirements), selecting a particular SMF 183a, 183b, management of the registration area, termination of non-access stratum (NAS) signaling, mobility management, and the like. Network slicing may be used by the AMF 182a, 182b in order to customize CN support for WTRUs 102a, 102b, 102c based on the types of services being utilized WTRUs 102a, 102b, 102c. For example, different network slices may be established for different use cases such as services relying on ultra-reliable low latency (URLLC) access, services relying on enhanced massive mobile broadband (eMBB) access, services for MTC access, and the like. The AMF 182a, 182b may provide a control plane function for switching between the RAN 104 and other RANs (not shown) that employ other radio technologies, such as LTE, LTE-A, LTE-A Pro, and/or non-3GPP access technologies such as WiFi.

The SMF 183a, 183b may be connected to an AMF 182a, 182b in the CN 106 via an N11 interface. The SMF 183a, 183b may also be connected to a UPF 184a, 184b in the CN 106 via an N4 interface. The SMF 183a, 183b may select and control the UPF 184a, 184b and configure the routing of traffic through the UPF 184a, 184b. The SMF 183a, 183b may perform other functions, such as managing and allocating UE IP address, managing PDU sessions, controlling policy enforcement and QoS, providing DL data notifications, and the like. A PDU session type may be IP-based, non-IP based, Ethernet-based, and the like.

The UPF 184a, 184b may be connected to one or more of the gNBs 180a, 180b, 180c in the RAN 104 via an N3 interface, which may provide the WTRUs 102a, 102b, 102c with access to packet-switched networks, such as the Internet 110, to facilitate communications between the WTRUs 102a, 102b, 102c and IP-enabled devices. The UPF 184, 184b may perform other functions, such as routing and forwarding packets, enforcing user plane policies, supporting multi-homed PDU sessions, handling user plane QoS, buffering DL packets, providing mobility anchoring, and the like.

The CN 106 may facilitate communications with other networks. For example, the CN 106 may include, or may communicate with, an IP gateway (e.g., an IP multimedia subsystem (IMS) server) that serves as an interface between the CN 106 and the PSTN 108. In addition, the CN 106 may provide the WTRUs 102a, 102b, 102c with access to the other networks 112, which may include other wired and/or wireless networks that are owned and/or operated by other service providers. In one embodiment, the WTRUs 102a, 102b, 102c may be connected to a local DN 185a, 185b through the UPF 184a, 184b via the N3 interface to the UPF 184a, 184b and an N6 interface between the UPF 184a, 184b and the DN 185a, 185b.

In view of FIGS. 1A-1D, and the corresponding description of FIGS. 1A-1D, one or more, or all, of the functions described herein with regard to one or more of: WTRU 102a-d, Base Station 114a-b, eNode-B 160a-c, MME 162, SGW 164, PGW 166, gNB 180a-c, AMF 182a-b, UPF 184a-b, SMF 183a-b, DN 185a-b, and/or any other device(s) described herein, may be performed by one or more emulation devices (not shown). The emulation devices may be one or more devices configured to emulate one or more, or all, of the functions described herein. For example, the emulation devices may be used to test other devices and/or to simulate network and/or WTRU functions.

The emulation devices may be designed to implement one or more tests of other devices in a lab environment and/or in an operator network environment. For example, the one or more emulation devices may perform the one or more, or all, functions while being fully or partially implemented and/or deployed as part of a wired and/or wireless communication network in order to test other devices within the communication network. The one or more emulation devices may perform the one or more, or all, functions while being temporarily implemented/deployed as part of a wired and/or wireless communication network. The emulation device may be directly coupled to another device for purposes of testing and/or performing testing using over-the-air wireless communications.

The one or more emulation devices may perform the one or more, including all, functions while not being implemented/deployed as part of a wired and/or wireless communication network. For example, the emulation devices may be utilized in a testing scenario in a testing laboratory and/or a non-deployed (e.g., testing) wired and/or wireless communication network in order to implement testing of one or more components. The one or more emulation devices may be test equipment. Direct RF coupling and/or wireless communications via RF circuitry (e.g., which may include one or more antennas) may be used by the emulation devices to transmit and/or receive data.

A WLAN in Infrastructure Basic Service Set (BSS) mode has an Access Point (AP) for the BSS and one or more stations (STAs) associated with the AP. The AP typically has access or interface to a Distribution System (DS) or another type of wired/wireless network that carries traffic in and out of the BSS. Traffic to STAs that originates from outside the BSS arrives through the AP and is delivered to the STAs. Traffic originating from STAs to destinations outside the BSS is sent to the AP to be delivered to the respective destinations. Traffic between STAs within the BSS may also be sent through the AP where the source STA sends traffic to the AP and the AP delivers the traffic to the destination STA.

Using the 802.11ac infrastructure mode of operation, the AP may transmit a beacon on a fixed channel, usually the primary channel. This channel may be 20 MHz wide, and is the operating channel of the BSS. This channel is also used by the STAs to establish a connection with the AP. The fundamental channel access mechanism in an 802.11 system is Carrier Sense Multiple Access with Collision Avoidance (CSMA/CA). In this mode of operation, every STA, including the AP, will sense the primary channel. If the channel is detected to be busy, the STA backs off. Hence only one STA may transmit at any given time in a given BSS.

In 802.11n, High Throughput (HT) STAs may also use a 40 MHz wide channel for communication. This is achieved by combining the primary 20 MHz channel, with an adjacent 20 MHz channel to form a 40 MHz wide contiguous channel.

In 802.11ac, Very High Throughput (VHT) STAs may support 20 MHz, 40 MHz, 80 MHz, and 160 MHz wide channels. The 40 MHz, and 80 MHz, channels are formed by combining contiguous 20 MHz channels similar to 802.11n described above. A 160 MHz channel may be formed either by combining eight contiguous 20 MHz channels, or by combining two non-contiguous 80 MHz channels, which may also be referred to as an 80+80 configuration. For the 80+80 configuration, the data, after channel encoding, is passed through a segment parser that divides it into two streams. The Inverse Discrete Fourier Transformation (IDFT) operation and time domain processing are done on each stream separately. The streams are then mapped on to the two channels, and the data is transmitted. At the receiver, this mechanism is reversed, and the combined data is sent to the MAC.

To improve spectral efficiency 802.11ac has introduced the concept for downlink Multi-User MIMO (MU-MIMO) transmission to multiple STA's in the same symbol's time frame, e.g. during a downlink OFDM symbol. The potential for the use of downlink MU-MIMO is also currently considered for 802.11ah. It is important to note that since downlink MU-MIMO, as it is used in 802.11ac, uses the same symbol timing to multiple STA's interference of the waveform transmissions to multiple STA's is not an issue. However, all STA's involved in MU-MIMO transmission with the AP must use the same channel or band, this limits the operating bandwidth to the smallest channel bandwidth that is supported by the STA's which are included in the MU-MIMO transmission with the AP.

IEEE 802.11be is referred to as Extremely High Throughput (EHT). EHT further increases peak throughput and improves efficiency of the IEEE 802.11 networks. EHT addresses primary use cases and applications including high throughput and low latency applications such as Video-over-WLAN, Augmented Reality (AR) and Virtual Reality (VR).

Features related to 802.11be EHT include: Multi-AP, Multi-Band/multi-link, 320 MHz bandwidth, 16-Spatial Streams, hybrid automatic repeat request (HARQ), AP Coordination and new designs for 6-GHz channel access, among others.

EHT STAs use the EHT sounding protocol to determine the channel state information. The EHT sounding protocol provides explicit feedback mechanisms, defined as EHT non-trigger-based (non-TB) sounding and EHT trigger-based (TB) sounding, where the EHT beamformer (BFer) determines the channel state by transmitting a training signal (i.e., an EHT sounding null data packet (NDP) to the EHT beamformee (BFee), which sends back a transformed estimate of the channel state. The EHT beamformer uses this estimate to derive the steering matrix.

The EHT beamformee returns an estimate of the channel state in an EHT compressed beamforming/CQI report carried in one or more EHT Compressed Beamforming/CQI frames. There are three types of EHT compressed beamforming/CQI reports. For SU feedback, the EHT compressed beamforming/CQI report consists of an EHT Compressed Beamforming Report field. For MU feedback, the EHT compressed beamforming/CQI report consists of an EHT Compressed Beamforming Report field and EHT MU Exclusive Beamforming Report field. For CQI feedback, the EHT compressed beamforming/CQI report consists of an EHT CQI Report field.

802.11be Multi-AP Transmission defines schemes for Coordinated multi-AP (C-MAP) transmissions including: Coordinated Multi-AP OFDMA; Coordinated Multi-AP TDMA; Coordinated Multi-AP Spatial Reuse; Coordinated beamforming/nulling; and Joint Transmission. In the context of coordinated Multi-AP, several terminologies have been defined including: Sharing AP—an EHT AP which obtains a TXOP and initiates the multi-AP coordination; Shared AP—an EHT AP which is coordinated for the multi-AP transmission by the sharing AP; and AP candidate set—a set of APs that may initiate or participate in multi-AP coordination

In embodiments, an AP that intends to use a resource (i.e., frequency or time) shared by another AP may indicate its resource needs to the AP that shared the resource. Coordinated OFDMA is supported in 11be, and in a coordinated OFDMA, both DL OFDMA and its corresponding UL OFDMA acknowledgement are allowed.

Channel sounding in 802.11n and 802.11ac is performed using two different schemes, explicit or implicit. In explicit channel sounding, the AP transmits an NDP to the STA with a preamble that allows the STA to measure its own channel and send CSI feedback to the AP. In implicit channel sounding, the STA sends an NDP, and the AP measures the channel of the STA assuming that the channel is reciprocal.

802.11be supports a maximum of 16-spatial streams for SU-MIMO and for MU-MIMO, the maximum number of spatial streams allocated to each MU-MIMO scheduled non-AP STA is limited to four. The maximum number of users spatially multiplexed for DL transmissions is eight per resource unit (RU).

802.11be supports two modes of channel sounding in Multiple-AP, sequential sounding, and joint sounding. In sequential sounding, each AP transmits an NDP independently without overlapped sounding period of each AP. Also, joint sounding is provided as optional mode for Multiple-AP, where when an AP has less or equal to a total of eight antennas, all antennas active on all long training field (LTF) tones and uses 802.11ax P-matrix across OFDM symbols. 802.11ax is referred to as high efficiency (HE) WLAN.

The CSI feedback collection may be performed using an 802.11ax-like 4-step sounding sequence (NDP announcement (NDPA)+NDP+beamforming report (BFRP) trigger frame (TF)+CSI report) in Multiple-AP to collect the feedback from both in-BSS and overlapping BSS (OBSS) STAs. Further, in sequential sounding for Multiple-AP, a STA can process an NDPA frame and the BFRP Trigger frame received from the OBSS AP and the STA can respond with the corresponding CSI to the OBSS AP, if polled by the BFRP TF from the OBSS AP.

EHT sounding feedback may be carried in a EHT Compressed Beamforming/CQI frame. The frame is an Action frame with Action field format shown in Table 1, below.

TABLE 1
EHT Compressed Beamforming/CQI frame Action field
format Error! Reference source not found.

| Order | Meaning |
|---|---|
| 1 | Category |
| 2 | EHT Action |
| 3 | EHT MIMO Control |
| 4 | EHT Compressed Beamforming Report |
| 5 | EHT MU Exclusive Beamforming Report |
| 6 | EHT CQI Report |

The EHT MIMO Control field is show in in Table 2, below

TABLE 2
EHT MIMO Control field format

| | Nc Index | Nr Index | BW | Grouping | Feedback Type | Reserved |
|---|---|---|---|---|---|---|
| Bits | 4 | 4 | 3 | 1 | 2 | 3 |
| | Remaining | | | Sounding Dialog | | |
| | Feedback | First Feedback | Partial | Token | Codebook | |
| | Segments | Segment | BW Info | Number | Information | Reserved |
| Bits | 3 | 1 | 9 | 6 | 1 | 3 |

In embodiments, if the EHT compressed beamforming/CQI report solicited by the EHT beamformer would result in an EHT Compressed Beamforming/CQI frame that exceeds 11454 octets in length, then the EHT compressed beamforming/CQI report may be split into up to eight feedback segments. Each feedback segment may be included in a separate EHT Compressed Beamforming/CQI frame and may contain successive portions of the EHT compressed beamforming/CQI report. Each feedback segment may be of equal length except the last feedback segment that may be smaller. Each EHT Compressed Beamforming/CQI frame that includes a feedback segment that is not the last feedback segment may have a length of 11454 octets. Each feedback segment may be identified by the value of a Remaining Feedback Segments subfield and a First Feedback Segment subfield in the EHT MIMO Control field. The other non-reserved subfields of the EHT MIMO Control field may be the same for all feedback segments. All feedback segments may be sent in an Aggregate MAC Protocol Data Unit (A-MPDU) contained in a single physical layer protocol data unit (PPDU) and may be included in the A-MPDU in the descending order of the values of a Remaining Feedback Segments subfield.

Embodiments for Channel State Information (CSI) Feedback and Segmentation are described herein. In embodiments, if MU CSI feedback is requested and segmentation is needed, then both a compressed beamforming report and an MU exclusive beamforming report may be segmented. Each feedback segment may be included in a Compressed Beamforming/CQI frame. The format of the Compressed Beamforming/CQI frame is shown above in Table 1, which may include a Compressed Beamforming Report field and an MU Exclusive Beamforming Report field. The presence of the MU Exclusive Beamforming Report field depends on the Feedback Type subfield carried in the MIMO Control field in the same Compressed Beamforming/CQI frame. In embodiments for VHT, HE and EHT, all the feedback segments that are carried in multiple Compressed Beamforming/CQI frames may be carried in an aggregated MPDU (A-MPDU), and the Feedback Type subfields in all Compressed Beamforming/CQI frames may be the same. This implies the MU Exclusive Beamforming Report field may be present in each Compressed Beamforming/CQI frame and thus a portion of MU exclusive beamforming report may be present in each feedback segment. Accordingly, in embodiments, both beamformer and beamformee know the size of the Compressed Beamforming Report field and MU Exclusive Beamforming Report field. In embodiments, a detailed segmentation procedure may be used.

In embodiments, a beamformer (BFer) may request a MU sounding feedback by setting the “Feedback Type And Ng” subfield in the NDP Announcement frame to be greater than 1 (meaning MU cases). The beamformer may transmit an NDP frame SIFS duration after the NDP Announcement frame. The beamformer may transmit a Beamforming Request Polling frame. A STA may transmit one or more Compressed Beamforming/CQI frames to feedback the compressed beamforming/CQI report.

Herein terms with capitalizing in the first letter for each word indicate a field/subfield/element/frame. For example, “Compressed Beamforming/CQI frame,” and “Compressed Beamforming Report field” etc. For the contents carried in a field/subfield/element/frame, terminology is used with small letter as the first letter for each word, for example, “compressed beamforming report.”

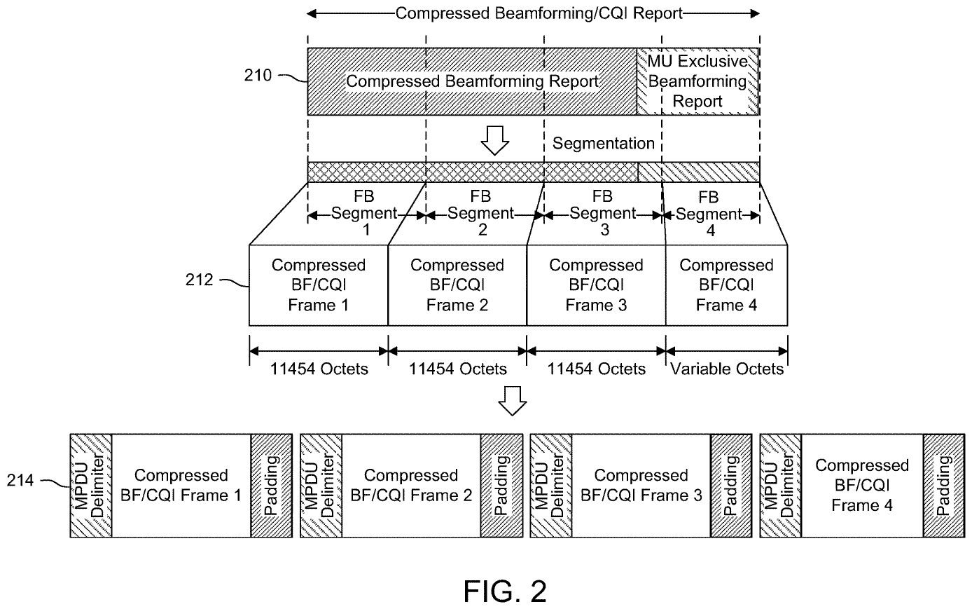

A first exemplary method is described herein and is referred to as Method I, an embodiment of which is shown in FIG. 2 In embodiments, a beamformee (BFee) may prepare the compressed beamforming/CQI report, including the compressed beamforming report and MU exclusive beamforming report, with segmentation using following procedures:

On reception of an NDP Announcement frame and an NDP frame, the BFee may prepare the compressed beamforming/CQI report including the compressed beamforming report and MU exclusive beamforming report (if MU report is requested by the BFer). If the size of the compressed beamforming/CQI report solicited by the BFer would result in an Compressed Beamforming/CQI frame that exceeds a threshold, e.g, 11,454 octets in length, then the compressed beamforming/CQI report may be split into multiple, e.g., up to eight, feedback segments.

According to embodiments of Method I, the compressed beamforming report and the MU exclusive beamforming report may be concatenated sequentially as shown in FIG. 2, which depicts fragmentation Method I of the compressed beamforming/CQI report, which consists of the compressed beamforming report and the MU exclusive beamforming report (collectively 210). Each feedback segment may contain successive portions of the compressed beamforming/CQI report which includes compressed beamforming report and/or MU exclusive beamforming report (shown 212). Each feedback segment may be of equal length except the last feedback segment that may be smaller. In this way, both the compressed beamforming report and the MU exclusive beamforming report may be contained in one or more feedback segment, but not in every feedback segment. In other words, some segments may contain the compressed beamforming report or MU exclusive beamforming report only, but not both (e.g. 212, segments 1, 2 and 4). In embodiments, some segments may contain both the compressed beamforming report and the MU exclusive beamforming report (e.g. 212, segment 3).

Each feedback segment may be included in a separate Compressed Beamforming/CQI frame. The Compressed Beamforming/CQI frame is an Action frame with Action field including:
Category field: this field indicates the category of the action frame.
Action field: this field indicates the Action frame type.
MIMO Control field: Remaining Feedback Segments subfield and the First Feedback Segment subfield in the MIMO Control field may be used to identify the feedback segment. In embodiments, the Feedback Type subfield in the MIMO Control field may be set following Method I.A and/or Method I.B descripted below. Other non-reserved subfields in the MIMO Control field may be the same for all feedback segments.

In embodiments according to one method (herein, Method I.A) the Feedback Type subfield in the MIMO Control field is set to MU. This setting remains the same for all feedback segments.

In embodiments according to a further method (herein, Method I.B) the Feedback Type subfield in the MIMO Control field is set to SU or MU depending on whether the feedback segment includes part or all of the MU exclusive beamforming report. In embodiments, this setting may be different from one feedback segment to another.

The Compressed Beamforming Report and the MU Exclusive Beamforming Report in embodiments, including those described with respect to Method I are described herein.

In embodiments according to one method (herein Method I.AA) although the Feedback Type subfield in the MIMO Control field is set to MU, each feedback segment, regardless whether it contains part of MU exclusive beamforming report, may be carried in the Compressed Beamforming Report.

In embodiments according to a further method, although the Feedback Type subfield in the MIMO Control field is set to MU, the part of a feedback segment corresponding to a compressed beamforming report (if present) may be carried in the Compressed Beamforming Report. The part of a feedback segment corresponding to a MU exclusive beamforming report (if present) may be carried in the MU Exclusive Beamforming Report.

In embodiments according to one method (herein Method I.BB), the part of a feedback segment corresponding to a compressed beamforming report (if present) may be carried in the Compressed Beamforming Report. The part of a feedback segment corresponding to a MU exclusive beamforming report (if present) may be carried in the MU Exclusive Beamforming Report. If MU Exclusive Beamforming Report is present, the Feedback Type subfield in the MIMO Control field may be set to MU, otherwise, it may be set to SU.

All the resulting Compressed Beamforming/CQI frames may be aggregated together (shown 214) in a A-MPDU and carried in a PPDU. The beamformee will transmit the PPDU back to the beamformer.

In embodiments, on reception of the PPDU, which carries an A-MPDU where each MPDU carries a Compressed BF/CQI frame, the beamformer may do the following:

For each received MPDU in the A-MPDU, check the frame check sequence (FCS).

If the FCS shows the MPDU is correctly detected, the beamformer may check the MIMO Control field in the Compressed BF/CQI frame.

By checking the Remaining Feedback Segments and First Feedback Segment subfields, the beamformer may know the sounding feedback is segmented.

For example, when the First Feedback Segment subfield is set to 0 and the Remaining Feedback Segments subfield is set to values between 0 and 6 (including 0 and 6), or the First Feedback Segment subfield is set to 1 and the Remaining Feedback Segments subfield is set to 7, the compressed beamforming/CQI report is segmented.

By checking the Feedback Type subfield in the MIMO Control field, the beamformer may know it is a MU feedback.

If the feedback is a MU feedback and segmented, the beamformer may concatenate the information carried in the Compressed Beamforming Report field and/or MU Exclusive Beamforming Report field in each Compressed BF/CQI frame together and retrieve the full compressed beamforming/CQI report.

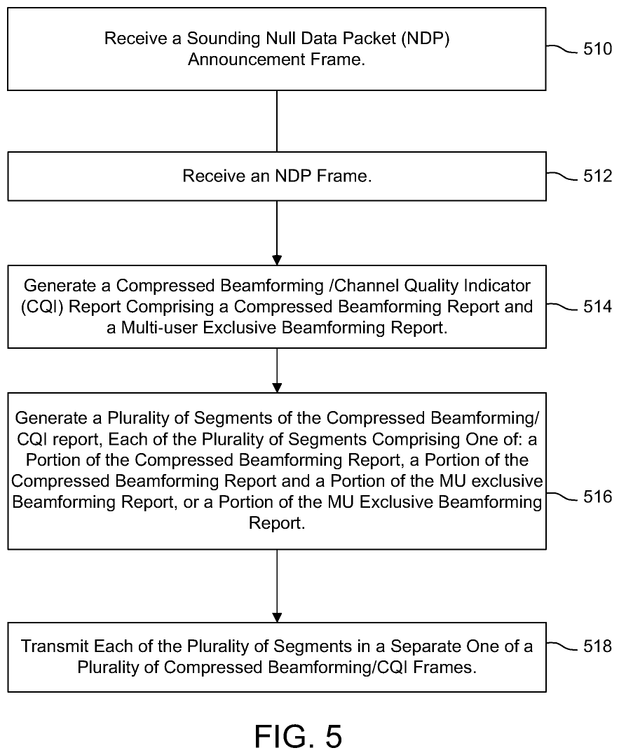

An exemplary process for forming a compressed beamforming report according to aspects of Method I is shown in FIG. 5. At 510, a beamformee WTRU receives a sounding null data packet announcement frame. At 512 the WTRU receives an NDP frame. At 514, the WTRU generates a compressed beamforming/channel quality indicator (CQI) report comprising a compressed beamforming report and a multi-user (MU) exclusive beamforming report; At 516, the WTRU generates a plurality of segments of the compressed beamforming/CQI report, each of the plurality of segments comprising one of: a portion of the compressed beamforming report, a portion of the compressed beamforming report and a portion of the MU exclusive beamforming report, or a portion of the MU exclusive beamforming report. At 518, the WTRU transmits each of the plurality of segments in a separate one of a plurality of compressed beamforming/CQI frames.

A second exemplary method for preparing a compressed beamforming report is described herein and is referred to herein as Method II.

In embodiments, a beamformee may prepare the compressed beamforming/CQI report, including the compressed beamforming report and MU exclusive beamforming report, with segmentation using following procedures:

On reception of an NDP Announcement frame and NDP frame, the BFee may prepare the compressed beamforming/CQI report including the compressed beamforming report and MU exclusive beamforming report (if MU report is requested by the BFer). If the size of the compressed beamforming/CQI report solicited by the BFer would result in an Compressed Beamforming/CQI frame that exceeds a threshold, e.g, 11,454 octets in length, then the compressed beamforming/CQI report may be split into up to eight feedback segments.

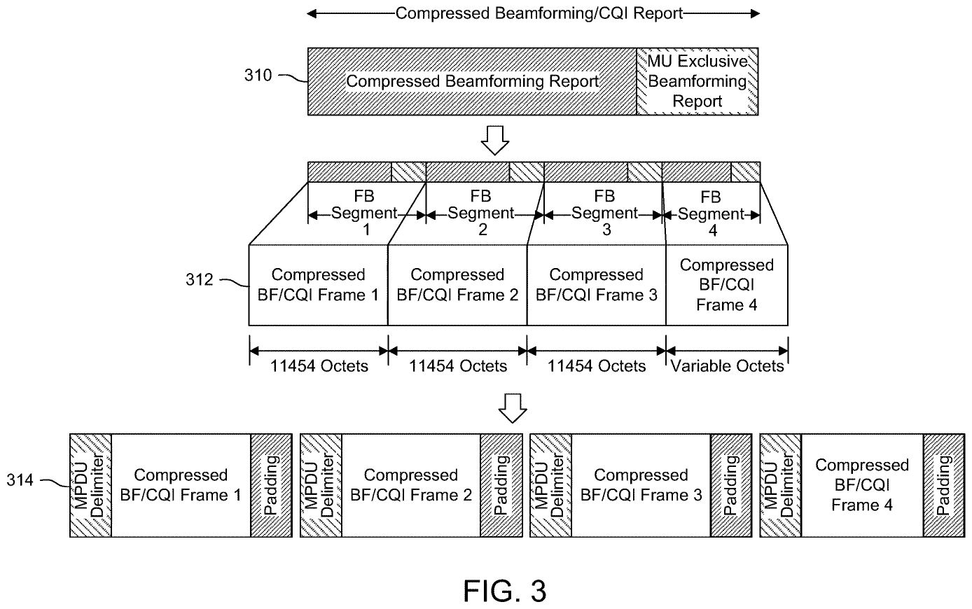

According to embodiments of Method II (as shown in FIG. 3), the compressed beamforming report and the MU exclusive beamforming report (shown together as 310) may be segmented in parallel, i.e., both the compressed beamforming report and the MU exclusive beamforming report may be segmented to N portions as shown in 312. The nth feedback segment may contain the nth portion of the compressed beamforming report and the nth portion of the MU exclusive beamforming report, where n=1, . . . , N. Each feedback segment may be of equal length except the last feedback segment that may be smaller. Each feedback segment may contain N1 octets from the compressed beamforming report and N2 octets from the MU exclusive beamforming report. The MU exclusive beamforming report may be contained in every feedback segment.

According to embodiments of Method II, the beamformee may follow the following method to segment:

The beamformee may calculate the number of feedback segments it may need to split. Each feedback segment may be of equal length except the last feedback segment that may be smaller. For example, each feedback segment except the last segment may have the same size, L_{segment}=Maximum MPDU size−overhead=Maximum MPDU size−MAC header size−Category field size−Action field size−MIMO Control field size−FCS field size octets. Then N=┌Lₜₒₜₐₗ/L_{segment}┐, where Lₜₒₜₐₗ is the total size of the compressed beamforming report and MU exclusive beamforming report. L_{segmentLast}=Lₜₒₜₐₗ−NL_{segment}. In one example, the Maximum MPDU size is 11,454 octets. N refers to the number of segments.

The beamformee may segment the MU exclusive beamforming report to N portions. Each portion may be of equal length except the last portion.

According to embodiments of Method II, the length of each portion except the last portion may be L_{PortionMU}=┌L_{MU}/N┐ and the length of last portion may be L_{PortionLastMU}=L_{MU}−L_{PortionMU}(N−1), where L_{MU} is the length of the MU exclusive beamforming report. In an embodiment, the length of each portion except the last portion may be LPortionMU=└L_{MU}/N┘ and the length of last portion may be L_{PortionLastMU}=L_{MU}−L_{PortionMU}(N−1). If L_{PortionLastMU}>L_{segmentLast}, adjust L_{PortionMU}=┌(L_{MU}−L_{segmentLast})/(N−1)┐, and L_{PortionLastMU}=L_{MU}−L_{PortionMU}(N−1).

According to embodiments of Method II, L_{PortionMU}=┌(L_{MU}−L_{segmentLast})/(N−1)┐, and L_{PortionLastMU}=L_{MU}−L_{PortionMU}(N−1).

The beamformee may segment the compressed beamforming report to N portions, e.g. 4 portions as shown in FIG. 3, 312, 314. For the portions except the last portion, the length of the portion would result in the feedback segment with a fixed size, e.g., L_{PortionBF}=L_{Segment}−L_{PortionMU} octets. The last portion of compressed beamforming report has a size L_{PortionLastBF}=L_{BF}−L_{PortionBF}(N−1), where L_{BF} is the size of the compressed beamforming report.

Each feedback segment may be composed of a portion of the compressed beamforming report followed by a portion of the MU exclusive beamforming report.

Each feedback segment may be included in a separate Compressed Beamforming/CQI frame. The Compressed Beamforming/CQI frame is an Action frame with Action field including:

Category field: this field indicate the category.

Action field: this field indicate the Action frame type.

MIMO Control field: Remaining Feedback Segments subfield and the First Feedback Segment subfield in the MIMO Control field may be used to identify the feedback segment. Feedback Type subfield in the MIMO Control field may indicate MU feedback.

The Compressed Beamforming Report field may include a portion of the compressed beamforming report and MU Exclusive Beamforming Report field may include a portion of the MU exclusive beamforming report.

In embodiments, all of the resulting Compressed Beamforming/CQI frames may be aggregated together into a A-MPDU and carried in a PPDU. The beamformee will transmit the PPDU back to the beamformer.

On reception of the PPDU which carries an A-MPDU where each MPDU carries a Compressed BF/CQI frame, the beamformer may do the following:

For each received MPDU in the A-MPDU, check the frame check sequence (FCS).

If the FCS shows the MPDU is correctly detected, the beamformer may check the MIMO Control field in the Compressed BF/CQI frame.

By checking the Remaining Feedback Segments and First Feedback Segment subfields, the beamformer may know the sounding feedback is segmented.

For example, when the First Feedback Segment subfield is set to 0 and the Remaining Feedback Segments subfield is set to values between 0 and 6 (including 0 and 6), or the First Feedback Segment subfield is set to 1 and the Remaining Feedback Segments subfield is set to 7, the compressed beamforming/CQI report is segmented.

By checking the Feedback Type subfield in the MIMO Control field, the beamformer may know it is a MU feedback.

If the feedback is a MU feedback and segmented, the beamformer may know the total size of the compressed beamforming report and MU exclusive beamforming report before segmentation. The beamformer may calculate the number of feedback segments (N) the beamformee may need to segment. The beamformer may calculate L_{PortionMU}, L_{PortionLastMU}, L_{PortionBF} and L_{PortionLastBF} using the same algorithm as the beamformee did. The beamformer then knows the size of Compressed Beamforming Report field and MU Exclusive Beamforming Report field in each Compressed Beamform/CQI frame. The whole compressed beamforming report and the MU exclusive beamforming report could be retrieved from received Compressed Beamforming/CQI frames.

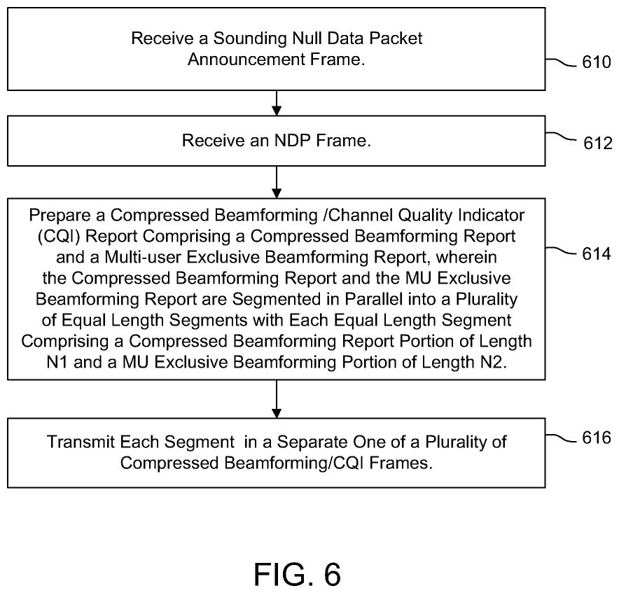

An exemplary process for forming a compressed beamforming report according to aspects of Method II is shown in FIG. 6. At 610, a beamformee WTRU receives a sounding null data packet announcement frame. At 612, the WTRU receives an NDP frame. At 614, the WTRU prepares a compressed beamforming/channel quality indicator (CQI) report comprising a compressed beamforming report and a multi-user (MU) exclusive beamforming report, wherein the compressed beamforming report and the MU exclusive beamforming report are segmented in parallel into a plurality of equal length segments with each equal length segment comprising a compressed beamforming report portion of length N1 and a MU exclusive beamforming portion of length N2. At 616, the WTRU may transmit each segment in a separate one of a plurality of Compressed Beamforming/CQI Frames.

A third exemplary method for preparing a compressed beamforming report is described herein and referred to as Method III.

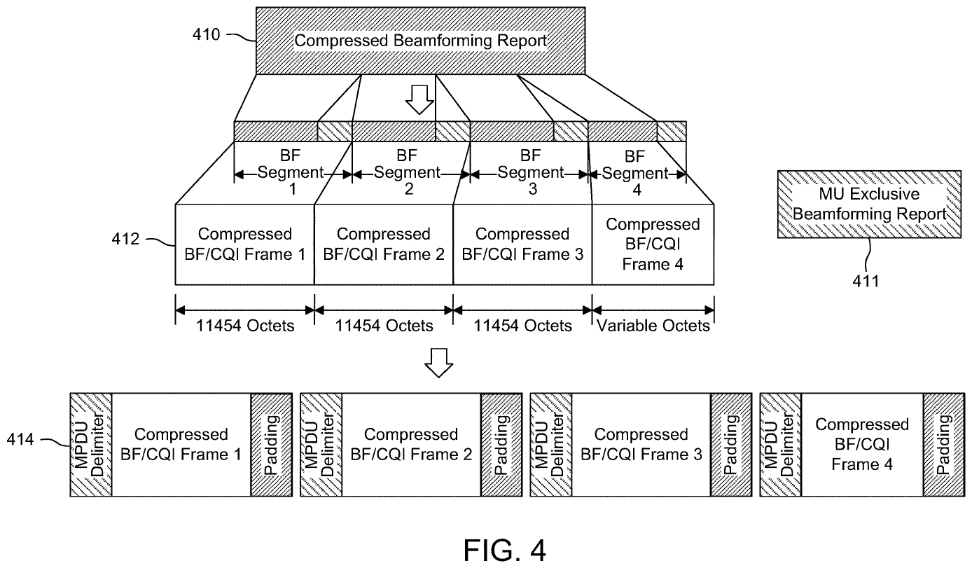

In embodiments according to Method III, and described in FIG. 4, the compressed beamforming report 410 may be split into up to 8 portions (as shown e.g. in 412 with 4 portions), while the MU exclusive beamforming report 411 may not be split. Instead, the entire MU exclusive beamforming report may be carried unsegmented in each Compressed Beamforming/CQI frame as shown in 412. Since the size of the entire MU exclusive report is fixed and known by both beamformer and beamformee, the feedback segments may be fully retrieved.

The described methods and signalings may be used in any versions of 802.11 and thus prefixes such as EHT, HE, VHT etc. are not stated before terminologies such as Compressed Beamforming/CQI frame, compressed beamforming report, MU exclusive beamforming report, MIMO Control field, Compressed Beamforming Report field, MU Exclusive Beamforming Report field etc. The prefix EHT, HE, VHT and EHT+ may be added. EHT+ here refers a future generation of 802.11. For example, Compressed Beamforming/CQI frame may refer to EHT Compressed Beamforming/CQI frame, or HE Compressed Beamforming/CQI frame, or VHT Compressed Beamforming/CQI frame, or EHT+Compressed Beamforming/CQI frame.

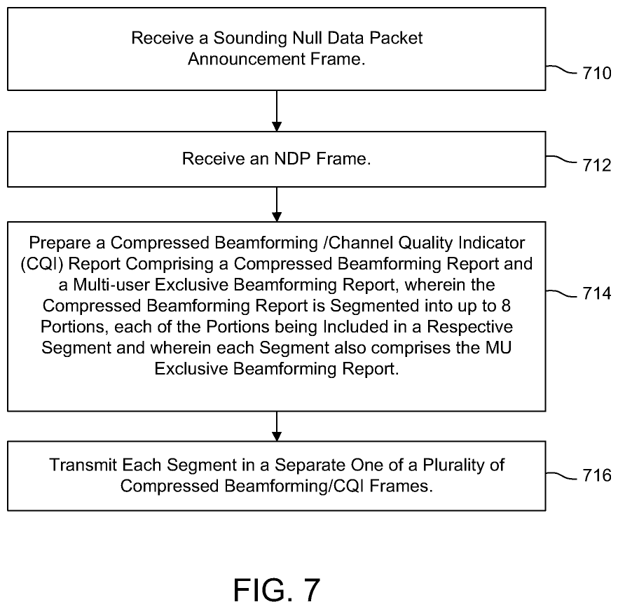

An exemplary process for forming a compressed beamforming report according to aspects of Method III is shown in FIG. 7. At 710, a beamformee WTRU receives a sounding null data packet announcement frame. At 712, the WTRU transmits an NDP frame. At 714, the WTRU prepares a compressed beamforming/channel quality indicator (CQI) report comprising a compressed beamforming report and a multi-user (MU) exclusive beamforming report; wherein the compressed beamforming report is segmented into up to 8 portions, each of the portions being included in a respective segment and wherein each segment also comprises the MU exclusive beamforming report. At 716, the WTRU may transmit each segment in a separate one of a plurality of Compressed Beamforming/CQI Frames.

Although features and elements are described above in particular combinations, one of ordinary skill in the art will appreciate that each feature or element can be used alone or in any combination with the other features and elements. In addition, the methods described herein may be implemented in a computer program, software, or firmware incorporated in a computer-readable medium for execution by a computer or processor. Examples of computer-readable media include electronic signals (transmitted over wired or wireless connections) and computer-readable storage media. Examples of computer-readable storage media include, but are not limited to, a read only memory (ROM), a random access memory (RAM), a register, cache memory, semiconductor memory devices, magnetic media such as internal hard disks and removable disks, magneto-optical media, and optical media such as CD-ROM disks, and digital versatile disks (DVDs). A processor in association with software may be used to implement a radio frequency transceiver for use in a WTRU, UE, terminal, base station, RNC, or any host computer.

1. A method implemented in a beamformee station (STA) comprising:
receiving a sounding null data packet (NDP) announcement (NDPA) frame;
receiving an NDP frame;
generating a compressed beamforming/channel quality indicator (CQI) report comprising a compressed beamforming report and a multi-user (MU) exclusive beamforming report;
generating a plurality of segments of the compressed beamforming/CQI report, at least one of the plurality of segments comprising
a portion of the compressed beamforming report and no portion of the MU exclusive beamforming report,
and at least another one of the plurality of segments comprising
a portion of the compressed beamforming report and a portion of the MU exclusive beamforming report, or
a portion of the MU exclusive beamforming report and no portion of the compressed beamforming report; and
transmitting each of the plurality of segments in a separate one of a plurality of compressed beamforming/CQI frames.

2. The method of claim 1, wherein one of the segments comprises portions of the compressed beamforming report and portions of the MU exclusive beamforming report.

3. (canceled)

4. (canceled)

5. The method of claim 1, wherein the method is performed in a case that the compressed beamforming report exceeds a predetermined frame size.

6. A station (STA) comprising:
a processor; and
a transceiver;
the processor and transceiver configured to receive a sounding null data packet (NDP) announcement (NDPA) frame;
the processor and transceiver further configured to receive an NDP frame;
the processor configured to generate a compressed beamforming/channel quality indicator (CQI) report comprising a compressed beamforming report and a multi-user (MU) exclusive beamforming report;
the processor further configured to generate a plurality of segments of the compressed beamforming/CQI report, at least one of the plurality of segments comprising
a portion of the compressed beamforming report and no portion of the MU exclusive beamforming report,
and at least another one of the plurality of segments comprising
a portion of the compressed beamforming report and a portion of the MU exclusive beamforming report, or
a portion of the MU exclusive beamforming report and no portion of the compressed beamforming report; and
the processor and transceiver further configured to transmit each of the plurality of segments in a separate one of a plurality of compressed beamforming/CQI frames.

7. The STA of claim 6, wherein one of the segments comprises portions of the compressed beamforming report and portions of the MU exclusive beamforming report.

8.-14. (canceled)

15. The method of claim 2, wherein the method is performed in a case that the compressed beamforming report exceeds a predetermined frame size.

16. The STA of claim 6, wherein at least another of the segments consists of portions of the MU exclusive beamforming report.
